(19) United States
(12) Patent Application Publication
(10) Pub. No.: US 2002/0003688 A1
(43) Pub. Date: Jan. 10, 2002

(54) System for monitoring power consumers in an electrical circuit

(75) Inventor: Josef Maria Brenner, Hachenburg (DE)

Correspondence Address: COLLARD & ROE, P.C., 1077 Northern Boulevard, Roslyn, NY, 11576, US

(73) Assignee: Servatec GmbH & Co. KG

(21) Appl. No.: 09/896,748

(22) Filed: Jun. 29, 2001

(30) Foreign Application Priority Data
Jun. 30, 2000 (DE) 200 11 519.7
Apr. 24, 2001 (EP) 011 09 896.9

(51) Int. Cl. H02H 3/08

(52) U.S. Cl. 361/93.6

(57) ABSTRACT

A measuring system for monitoring power consumers in an electrical circuit. The system measures the current intensity in the circuit. A comparator compares the current intensity to a predetermined threshold value and emits a signal if the threshold value is exceeded. A signalizer provides a visual or audible alarm when a person exits the monitored area without deactivating the system.

### BACKGROUND OF THE INVENTION

1. Field of the Invention

This invention relates to a system for monitoring power consumers in an electrical circuit serving a defined power supply or housing area.

2. The Prior Art

Typically, fires are caused by electrical appliances inadvertently left on, for example hair dryers, or ovens. Overheating can be avoided by temperature detectors or thermostats. However, these devices are not always successful, since the normal operating temperature of some electric appliances is already hot enough to set a fire.

German Patent Application 198 25 657 A1 discloses an infrared motion detector that shuts off the respective appliance unit when a person is not detected near the appliance. This device requires that all appliances in the household be replaced with modern appliances, and the infrared detector would have to be a safety standard. If not a standard, the risk would still exist because hazardous equipment not fitted with an infrared sensor would still be commercially offered for sale and commercially available in the market.

A power supply or living area is fitted with a master switch, such that the circuit allocated to that area is deactivated when the area is empty. However, this is not practical because many areas, for example an office, a workshop, a one-family house, an apartment etc., are normally provided with continuously operating electrical power items, electrical clocks, entertainment electronics, cooling equipment, telephone answering machines, communication facilities, extended time testers and many others.

Moreover, a person leaving the respective area might inadvertently turn off the power feed while other people are still in the area.

### SUMMARY OF THE INVENTION

It is an object of the present invention to provide a device that is cost-effective and adapted for use with already existing electronic items. The device is also easy to install. Another object is to allow any person leaving a defined area to turn off the power feed while another person is still present in that area.

These and other objects are accomplished by providing a measuring system to measure the current intensity, or any parameter relevant thereto, in a circuit. A comparator compares the current intensity to a threshold value and provides a control signal when the threshold value is being exceeded. A sensor detects if a person is leaving the respective area. At least one signalizer and at least one cutout means is also provided. The signalizer provides a visual or audible alarm when a person is leaving the boundaries, and the cutout means shuts off the power feed to the area being monitored, unless it is deactivated.

Normally all fire hazardous electrical appliances are high-power, and all continuously operating electronics are low-power consumers. For this reason, the threshold value selected is below the current intensity that is reached when a fire hazardous electric appliance is operating. This value is never reached by the total of all continuously operating electrical appliances. This threshold value can be specifically adapted to any particular system by means of a controller.

If the person leaves the designated area, the power in the supply system is monitored. If the current intensity exceeds the threshold value, an electric control signal is emitted by the comparator and is passed to the signalizer by the sensor to detect when a person is leaving the area, or the sensor provides a control signal to the signalizer to release a visible or audible signal.

In a preferred embodiment, a switch that can be turned off is fitted to the entrance door of the area being monitored. An audible signal is released at the entrance door. A visual signal may also be used that is within the field of view of the person leaving the area.

Every time the entrance door is opened, the person leaving the area will perceive the signal that is positioned such that the signal light cannot escape the person's attention.

In the case where there are a plurality of entrance doors, each of the doors will be fitted with a detector, preferably a closed switch with an associated signalizer.

Installation of the system is easy since the current intensity measuring system and the comparator are installed in the meter cubicle or power distribution panel serving the circuit. The measuring system may be a built-in type, either wholly or in part, and adapted to be looped into the phases of the supply system.

An open switch and visual signalizer are fitted to the entrance door and a light-current wire connects them to a meter or distribution panel. The light-current wire is inconspicuous and can be bonded to masonry or plaster surfaces.

It is preferred that at least part of the detector, signalizer, actuating means and switch for deactivating the cutout device be combined into one package unit.

In the case when the comparator and cutout means are provided, they are integrally installed in the electronic control system.

As mentioned earlier, the connection between the electronic control system and the equipment unit may be established by a wire line. A wireless connection in place of the wire may also be used. It is preferred that a radio link in the VHF range is used.

The system according to the present invention may be installed in any existing area. Electrical appliances of any kind can be equally monitored after installation.

It is also possible to skip individual circuits, such as a circuit for a water heater or lighting circuits. Therefore, a signal would not be released by any automatically operating hot water generating system or any main lighting system that remains on in the evening.

Some electrical appliances, such as irons, are fitted with thermostats that turn off the appliance when it reaches a predetermined maximum temperature, and then turns it on again when a predetermined minimum temperature is reached.

To enable this system to monitor appliances, a time-delay means is provided. Upon termination of a preset temperature condition, the time delay device continues to release a control signal to the signalizer for a predetermined length of time. This length of time is longer than the time between turn-off and reactivation of the thermostat-controlled electrical appliance. Since this time will usually not exceed 7 minutes, a duration of 10 minutes is considered adequate for the time-delay device to remain ready to release the control signal.

If under borderline conditions, the time-delay device will emit a false alarm shortly after the appliance is turned off. An alarm is not withheld or suppressed as long as the electrical device remains ON, not even when it is in an intermittent idling state.

The system also includes a current transformer to reduce the current intensity as measured and to send the resultant value to an electronic system. One current transformer is provided for each phase, i.e. a total of three transformers will transfer their output values to the electronic system in the case of a three phase supply. The electronic system will compare the current intensity with a preset value representing the intensity for operation of a fire hazardous electric appliance.

The values processed by the system are dependent on such local conditions, such as the preset value, the conversion ratio of the current transformers, the delay time or internal values and parameters. It is preferred that at least one of these factors be preset such that the system can always be operable within an optimal range.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a circuit diagram of a first embodiment of the present invention in which all three phases of a three phase line are monitored;

FIG. 2 shows a diagram for an apartment of which a part of the living space is being monitored;

FIG. 3 shows a circuit diagram of FIG. 1 including a modified signalizer; and

FIG. 4 shows a circuit diagram of another embodiment of the invention.

### DETAILED DESCRIPTION OF THE PREFERRED EMBODIMENT

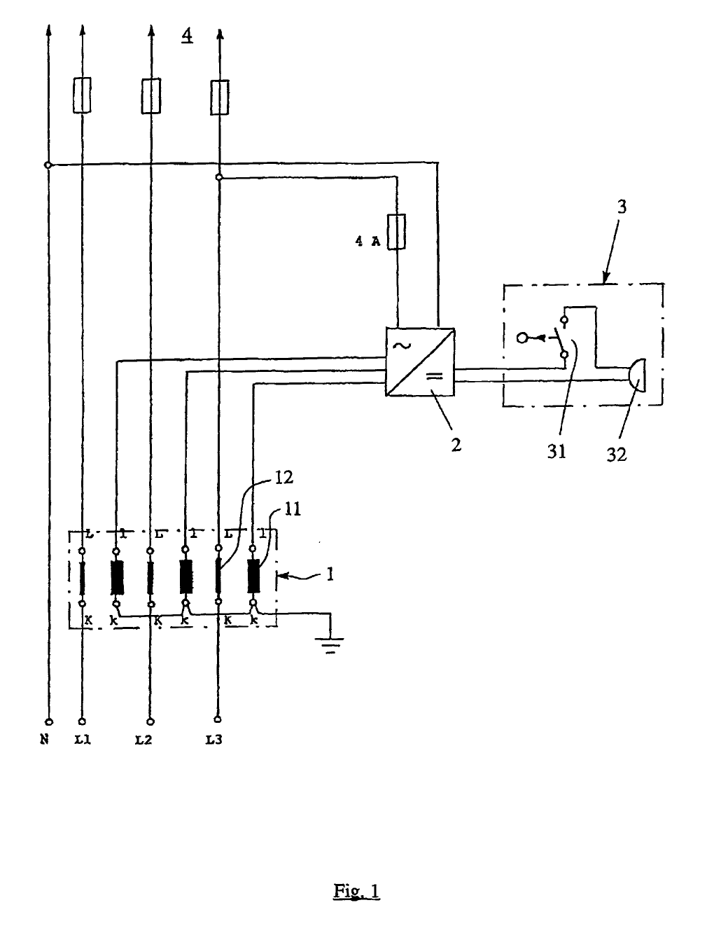

Referring now in detail to the drawings and, in particular, FIG. 1 shows a circuit diagram of a neutral conductor N and three current-carrying conductors L1, L2 and L3 of a three phase circuit. Conductors L1, L2 and L3 enter the distribution panel (not shown) of an office, a workshop, a household or the like and are carried to consumers 4.

Looped into each of current-carrying conductors L1, L2, L3 is a primary coil 12 forming a multiplier. One secondary coil 11 is allocated to each primary coil 12. This arrangement of primary and secondary coils 12, 11 provides a current transformer having its output carried to a comparator forming an integral part of electronic control system 2.

Electronic control system 2 contains connections coupled to incoming and outgoing lines. This unit may comprise correcting elements for adapting to specific conditions and requirements.

When the measured value obtained by transformer set 1 compared in electronic control system 2 exceeds a predetermined value, a control signal is sent to signalizer 3. When the measured value is less than the predetermined value, the control signal subsists for a predetermined length of time to bridge the startup and cutout period of a thermostat in a fire hazardous electrical appliance.

Signalizer 3 comprises a working type door switch 31 connected in series to an audible alarm 32. Door switch 31 is disposed at the main entrance door of monitored area. When the door (not shown) is opened, switch 31 will close and in response to the control signal (i.e. when a fire hazardous electric appliance is on) audible alarm 32 will give off a warning sound.

In areas having more than one entrance, one signalizer 3 is allocated to each of the entrances and all signalizers are connected in parallel.

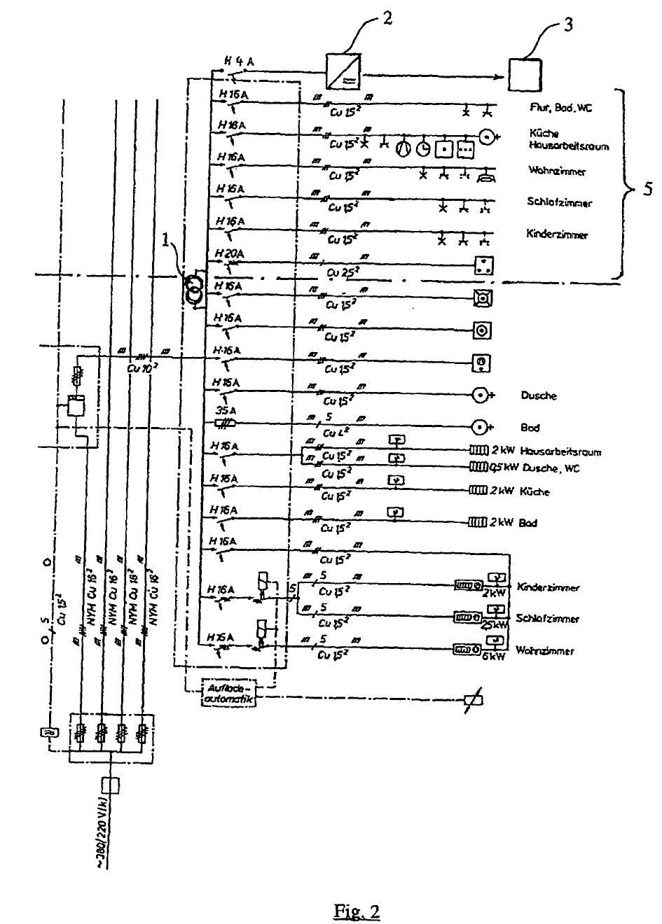

FIG. 2 shows a diagram of an apartment in which each of the circuits is separately fused with an automatic circuit breaker. Current transformer 1 is provided for monitoring the current flowing through the monitored area and for supplying power to electronic system 2. A control signal is provided when the current threshold value is exceeded and activates signalizer 3 not illustrated in FIG. 2.

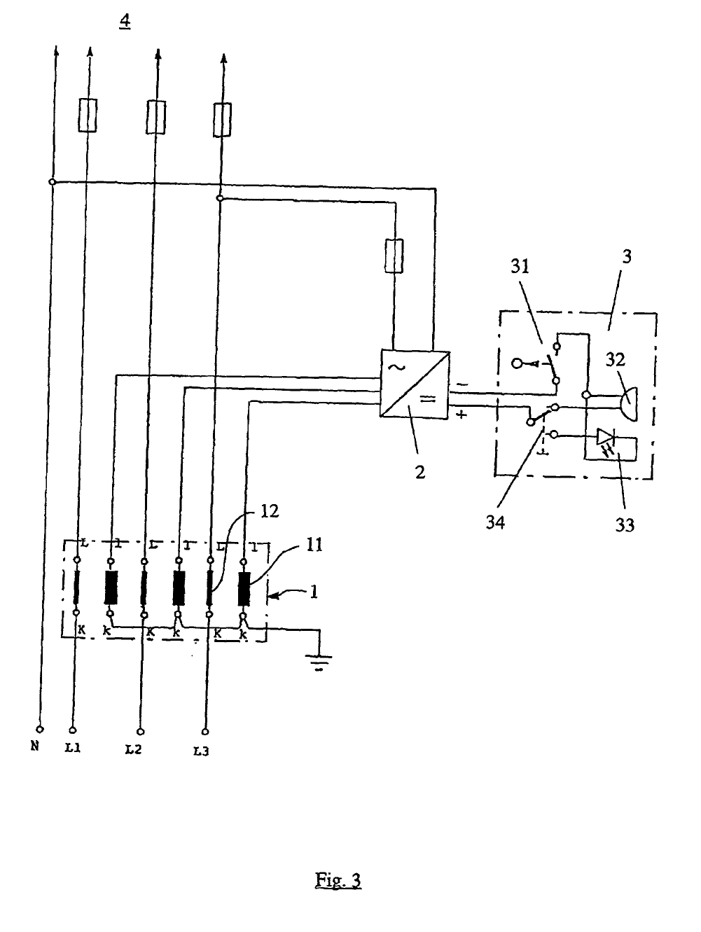

FIG. 3 shows the circuit arrangement of FIG. 1 containing a modified signalizer 3 having an audible alarm 32 and a visual signal generator 33, for instance, a light emitting diode. A manual changeover switch 34 is provided to selectively change the operating mode between audible alarm 32 and visual signal generator 33. For instance, at night a visible signal may be preferred so as not to disturb people living in the neighborhood.

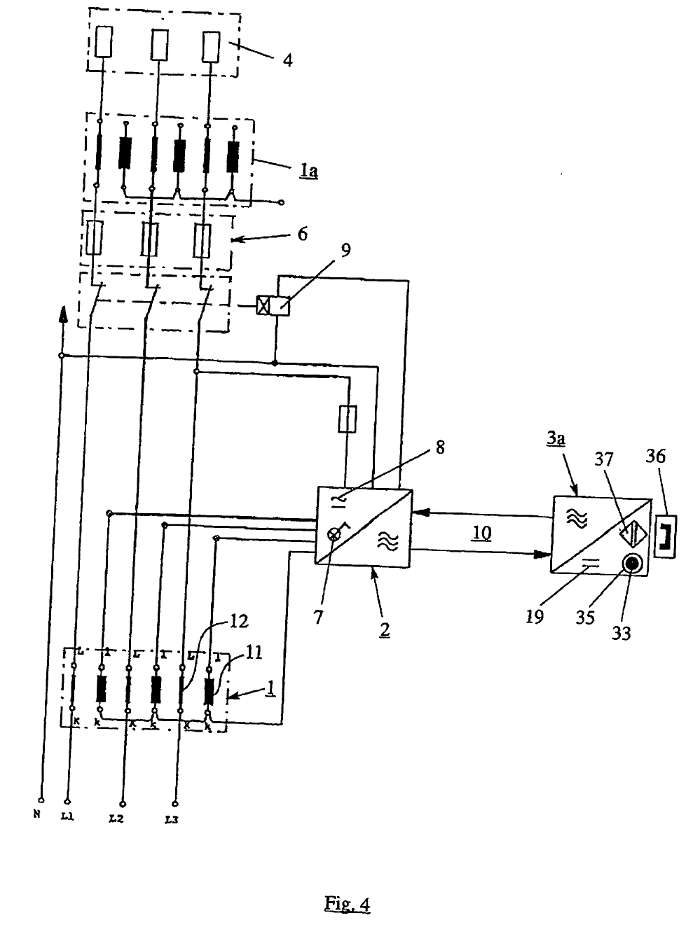

FIG. 4 shows a circuit diagram of a modified embodiment specifically intended for an apartment of an elder person who is living alone. In this case, additional current transformers 1a are provided for monitoring separate circuits, each one serving to additionally protect specific circuits that are considered neuralgic.

Electronic control system 2 is provided with a mains-operated power pack 8 and an activator switch 7 to activate a cutout means 6 via an electromagnet 9. Activator switch 7 may also be included in the unit 3a.

The unit is fitted to the apartment door opposite a stationary permanent magnet 36.

Unit 3a includes a reed switch 37 which is adapted to change its switching state and emit a signal when the apartment door is opened. Reed switch 37 comprises a twin type memory to detect when an inhabitant exits the area being monitored, and three switching states are detected and stored:

1. apartment door open

2. apartment door closed

3. nonactuation of acknowledgment switch 35.

Package unit 3a includes a battery set 19 and an alarm 33 coupled to an acknowledgment push-button 35 or activator switch 7. A radio link 10 between electronic control system 2 and package unit 3a is used instead of the wire line shown in FIG. 1.

Functional performance of the arrangement shown in FIG. 4 is different from that shown in FIGS. 1-3 because of activator switch 7, cutout means 6 and deactivator switch 35. Furthermore, current transformers la are provided for subordinate circuits.

When activator switch 7 is inoperative, the functional performance of the circuit arrangement in FIG. 4 is substantially identical to the circuit arrangement shown in FIG. 1. Therefore, alarm 33 responds when an occupant is leaving the apartment and a high-consumption electric appliance is left on.

For instance, if an occupant has forgotten to turn off an electric iron and has overlooked alarm signal 33, cutout means 6 is rendered inoperative via contactor coil 9. Contactor coil 9 is activated by control system 2 via activator switch 7.

On the other hand, when a heater is on and remains in the on state, the occupant may press the acknowledgment push-button 7 as alarm 33 lights up. This will prevent cut-out means 6 from activating via activator switch 7 and contactor coil 9 cuts off the power feed.

Radio link 10 facilitates installation of the system, and prevents damage to a connecting line during future installation work.

Accordingly, while only a few embodiments of the present invention have been shown and described, it is obvious that many changes and modifications may be made thereunto without departing from the spirit and scope of the invention.

What is claimed is:

1. A system for monitoring an area containing electrical devices within a confined circuit, comprising:
a measuring system (1) for measuring a current intensity in the circuit;
a comparator (2) for comparing the circuit intensity to a predetermined threshold value, wherein said comparator emits a control signal when the threshold value is exceeded;
a sensor means (31) for detecting when a person exits the area being monitored; and
at least one signalizer (32) for providing an alarm when a person exits the area.

2. The system according to claim 1, further comprising an acknowledgment pushbutton (35) for deactivating the system, wherein said pushbutton is depressed each time said cutout means is to be activated.

3. The system according to claim 3, wherein at least part of said measuring means (37), said signalizer (33) and said acknowledgment pushbutton (35) are combined into one unit (3a ).

4. The system according to claim 4, wherein said at least one comparator and said at least one cutout means are combined forming an electronic control system (2).

5. The system according to claim 5, wherein said unit (3a ) and said electronic control system (2) are connected by a wire line.

6. The system according to claim 5, wherein a wireless connection connects said unit (3a ) and said electronic control system (2).

7. The system according to claim 1, further comprising a time-delay unit for maintaining said control signal for a defined length of time after an occupant has left the area being monitored.

8. The system according to claim 1, wherein the measuring system (1) comprises at least one current transformer (11, 12) allocated to at least one phase, and an output from said current transformer (11, 12) is transferred to said comparator supplying the measured signal.

9. The system according to claim 1, wherein said measuring unit (31, 37) comprises a sensor at an entrance door and that said measuring unit (37) comprises a twin type memory to detect when a person is leaving the monitored area.

10. The system according to claim 1, further comprising at least one correcting element for adapting the system to specified operating conditions.

11. The system according to claim 1, wherein the threshold value conforms to such a current intensity as would be incurred with a power consumption of 600 W.

12. The system according to claim 1, wherein the circuit is part of a complete system for feeding power to the area being monitored.

13. The system according to claim 1, further comprising at least one cutout means (6) for turning off the electrical devices in the area monitored unless the system was deactivated.

14. The system according to claim 13, wherein the twin type memory inside said sensor emits a control signal to the cutout means (6) unless the acknowledgment pushbutton (35) has been pushed.
